(19) United States
(12) Patent Application Publication
(10) Pub. No.: US 2021/0382425 A1
(43) Pub. Date: Dec. 9, 2021

(54) FIXING DEVICE AND IMAGE FORMING APPARATUS CAPABLE OF RESTRICTING REDUCTION OF TEMPERATURE OF FIXING BELT

(71) Applicant: KYOCERA Document Solutions Inc., Osaka (JP)

(72) Inventors: Fumito Nakamoto, Osaka (JP); Masakazu Uehara, Osaka (JP); Tomohiro Watatani, Osaka (JP); Yuhiro Sakai, Osaka (JP)

(21) Appl. No.: 17/342,035

(22) Filed: Jun. 8, 2021

(30) Foreign Application Priority Data
Jun. 9, 2020 (JP) 2020-100087

(51) Int. Cl. G03G 15/20

(52) U.S. Cl. CPC G03G 15/2053

(57) ABSTRACT

A fixing device includes a fixing belt, a pressure applying member, and a heater holding member. The fixing belt fixes a toner image to a sheet. The pressure applying member forms a nip portion together with an outer peripheral surface of the fixing belt. The heater holding member holds a heater that applies heat to the fixing belt. The heater holding member includes a side portion and a rib. The side portion extends from the nip portion along an inner peripheral surface of the fixing belt and guides the fixing belt. The rib stands on the side portion and extends from a fixing belt conveyance direction downstream end of the nip portion where the fixing belt and the heater holding member are in contact with each other, toward a downstream in a peripheral rotation direction of the fixing belt, and guides the fixing belt to peripherally rotate.

### INCORPORATION BY REFERENCE

This application is based upon and claims the benefit of priority from the corresponding Japanese Patent Application No. 2020-100087 filed on Jun. 9, 2020, the entire contents of which are incorporated herein by reference.

### BACKGROUND

The present disclosure relates to a fixing device and an image forming apparatus.

There is known an image heating device including a heating body, a film, and a heating body support member as a film guide.

### SUMMARY

A fixing device according to an aspect of the present disclosure includes a fixing belt, a pressure applying member, and a heater holding member. The fixing belt fixes a toner image to a sheet. The pressure applying member forms a nip portion together with an outer peripheral surface of the fixing belt and causes the fixing belt to peripherally rotate while applying pressure to the fixing belt at the nip portion. The heater holding member holds a heater that applies heat to the fixing belt. The heater holding member includes a side portion and a rib. The side portion extends from the nip portion along an inner peripheral surface of the fixing belt and guides the fixing belt. The rib is formed to stand on the side portion and extend from a fixing belt conveyance direction downstream end of the nip portion where the fixing belt and the heater holding member are in contact with each other, toward a downstream in a peripheral rotation direction of the fixing belt, and guide the fixing belt to peripherally rotate.

An image forming apparatus according to another aspect of the present disclosure includes the fixing device described above and an image forming portion. The image forming portion is configured to form an image on the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an image forming apparatus including a fixing device according to Embodiment 1 of the present disclosure.

FIG. 2 is a perspective diagram showing a main part of the fixing device according to Embodiment 1.

FIG. 3 is a cross-section diagram taken along a line of FIG. 2.

FIG. 4 is an outline perspective diagram of a heater holding member provided in a general fixing device.

FIG. 5 is an outline perspective diagram of a heater holding member provided in the fixing device according to Embodiment 1.

FIG. 6 is a detailed diagram of the heater holding member provided in the general fixing device.

FIG. 7 is a detailed diagram of the heater holding member provided in the fixing device according to Embodiment 1.

FIG. 8 is a diagram of the heater holding member of the fixing device according to Embodiment 2 viewed from a positive side of Z-axis.

FIG. 9 is a diagram of the heater holding member of the fixing device according to Embodiment 2 viewed from a negative side of Z-axis.

FIG. 10 is a diagram of the heater holding member of the fixing device according to Embodiment 3 viewed from a positive side of X-axis.

### DETAILED DESCRIPTION

### Embodiment 1

The following describes Embodiment 1 of the present disclosure with reference to the accompanying drawings. It is noted that in the drawings, same or similar portions are assigned the same reference signs, and the explanation is not repeated. In addition, in Embodiment 1, X-axis, Y-axis, and Z-axis that are perpendicular to each other are shown in the drawings. The Z-axis is parallel to a vertical plane, and the X-axis and the Y-axis are parallel to a horizontal plane.

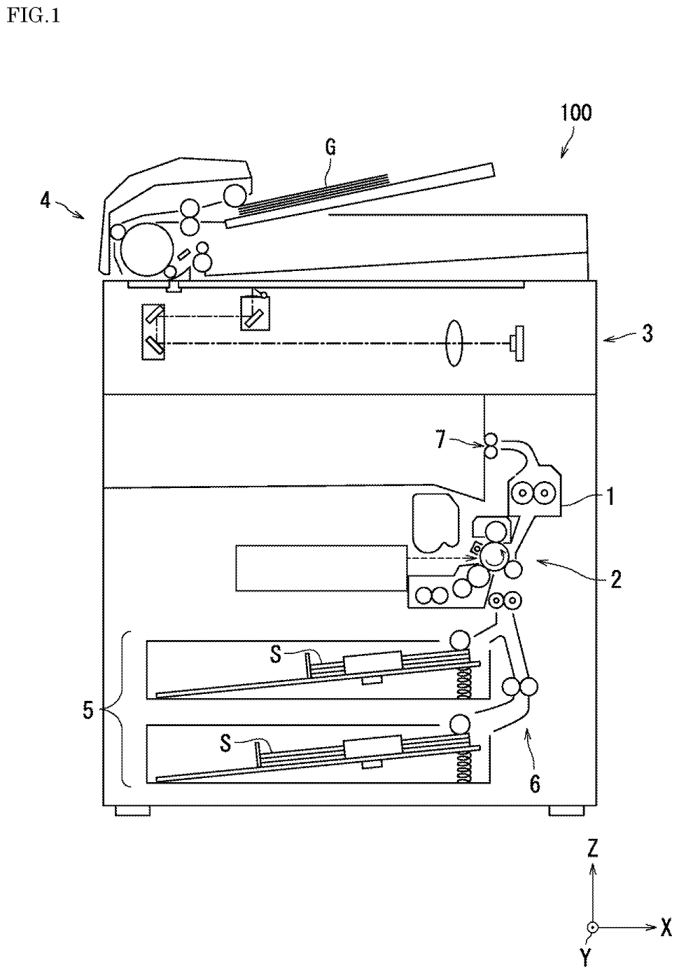

The following describes an image forming apparatus 100 according to Embodiment 1 of the present disclosure with reference to FIG. 1. FIG. 1 is a diagram showing the image forming apparatus 100 according to Embodiment 1. The image forming apparatus 100 is, for example, a copier, a facsimile, or a multifunction peripheral having functions of these. In Embodiment 1, the image forming apparatus 100 is a monochrome multifunction peripheral.

As shown in FIG. 1, the image forming apparatus 100 includes a fixing device 1, an image forming portion 2, a reading portion 3, a document sheet conveyance portion 4, a sheet feed portion 5, a conveyance portion 6, and a discharge portion 7.

The sheet feed portion 5 feeds a sheet S. The sheet feed portion 5 may include a tray and a pickup roller. The sheet S is stacked on the tray. The pickup roller picks up the sheet S on the tray and feeds the sheet S. The sheet S is an example of a recording medium.

The conveyance portion 6 conveys the sheet S fed from the sheet feed portion 5. The conveyance portion 6 may include a conveyance roller and a registration roller in a conveyance path. A plurality of conveyance rollers may be disposed in the conveyance path. The conveyance rollers convey the sheet S. The registration roller adjusts a timing at which the sheet S is conveyed to the image forming portion 2. The conveyance portion 6 conveys the sheet S from the sheet feed portion 5 to the discharge portion 7 via the image forming portion 2 and the fixing device 1.

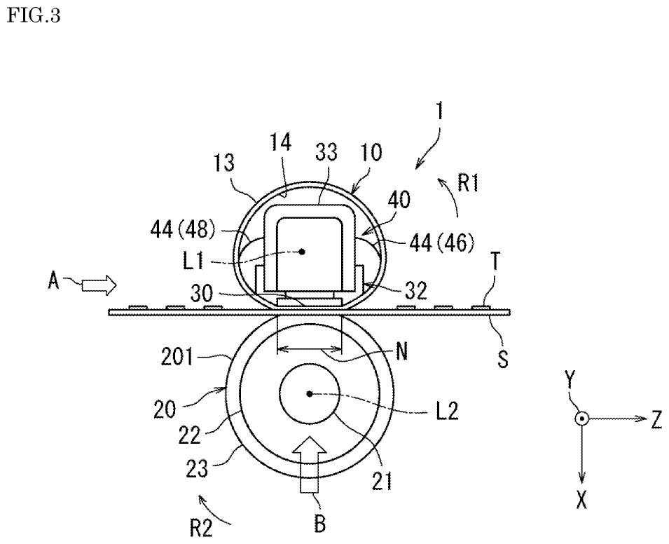

The image forming portion 2 forms a toner image T (FIG. 3) on the sheet S by an electrophotographic method based on image data. The image data represents, for example, an image of a document sheet G. The image forming portion 2 includes, for example, a photoconductor drum, a charging device, an exposure device, a developing device, a replenishing device, a transfer roller, a cleaning device, and an electricity removing device.

The fixing device 1 fixes the toner image T to the sheet S by heating and pressing the toner image T.

The discharge portion 7 discharges the sheet S to outside of a housing of the image forming apparatus 100. The discharge portion 7 may include a discharge roller and a discharge tray. The discharge roller discharges the sheet S that has been conveyed from the fixing device 1 by the conveyance roller, onto the discharge tray. The discharged sheet S is stacked on the discharge tray.

The document sheet conveyance portion 4 conveys the document sheet G. The document sheet conveyance portion 4 is, for example, an ADF (Auto Document Feeder).

The reading portion 3 reads an image of the document sheet G conveyed by the document sheet conveyance portion 4. The reading portion 3 generates image data from the read image. The reading portion 3 may be, for example, a scanner adopting a CIS (Contact Image Sensor) method or a CCD (Charge Coupled Devices) method.

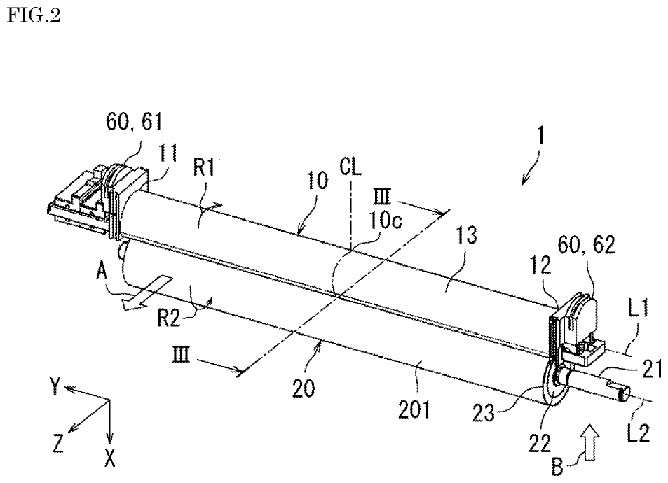

Next, the following describes a detailed configuration of the fixing device 1 according to Embodiment 1 with reference to FIG. 2 and FIG. 3. FIG. 2 is a perspective diagram showing a main part of the fixing device 1 according to Embodiment 1. FIG. 3 is a cross-section diagram taken along a line of FIG. 2.

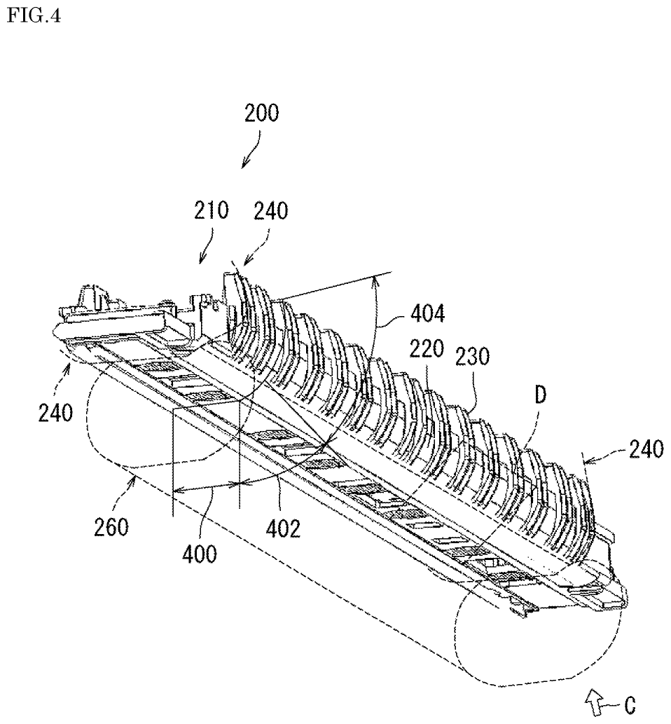

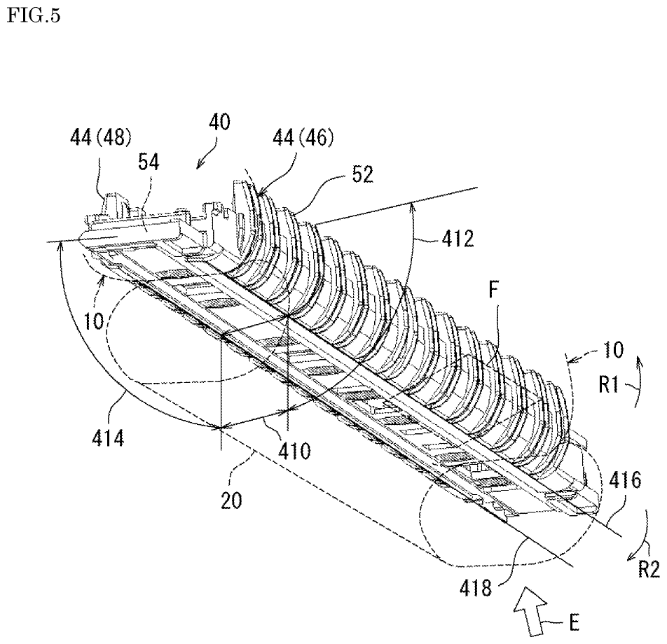

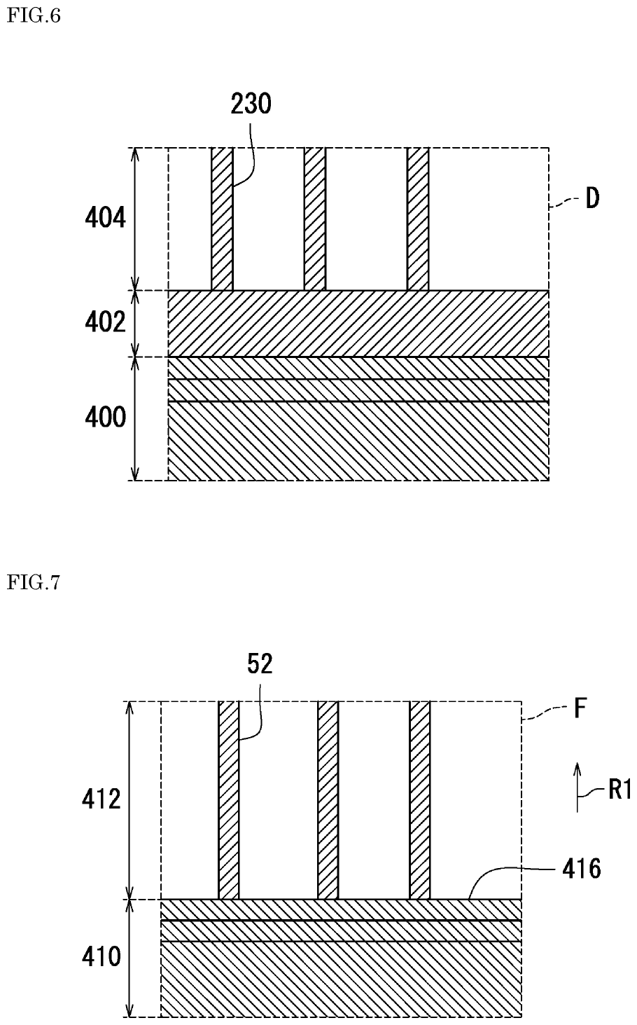

FIG. 4 is an outline perspective diagram of a heater holding member 210 provided in a general fixing device. FIG. 5 is an outline perspective diagram of a heater holding member 40 provided in the fixing device 1 according to Embodiment 1. FIG. 6 is a detailed diagram of the heater holding member 210 provided in the general fixing device. FIG. 7 is a detailed diagram of the heater holding member 40 provided in the fixing device 1 according to Embodiment 1.

As shown in FIG. 2 and FIG. 3, in Embodiment 1, the fixing device 1 includes a fixing belt 10, a pressure applying member 20, and the heater holding member 40.

As shown in FIG. 2 and FIG. 3, the fixing belt 10 fixes the toner image T to the sheet S. The pressure applying member 20 forms a nip portion N together with an outer peripheral surface 13 of the fixing belt 10, and causes the fixing belt 10 to peripherally rotate by applying pressure to the fixing belt 10 at the nip portion N. The heater holding member 40 holds a heater 30.

As shown in FIG. 5 and FIG. 7, the heater holding member 40 includes a side portion 44 and ribs 52. The side portion 44 extends from the nip portion N along an inner peripheral surface 14 of the fixing belt 10, and guides the fixing belt 10. The plurality of ribs 52 are formed to stand on the side portion 44 and extend from a fixing belt conveyance direction downstream end 416 of the nip portion N where the fixing belt 10 and the heater holding member 40 are in contact with each other, toward the downstream in a peripheral rotation direction R1 of the fixing belt 10, and the plurality of ribs 52 guide the fixing belt 10 to peripherally rotate.

In addition, in Embodiment 1, the heater holding member 40 further includes a rib 54. The rib 54 is formed to stand on an upstream side portion 48 and extend from a fixing belt conveyance direction upstream end 418 of the nip portion N where the fixing belt 10 and the heater holding member 40 are in contact with each other, toward the upstream in the peripheral rotation direction R1 of the fixing belt 10, and the rib 54 guides the fixing belt 10 to peripherally rotate.

In the following, a detailed description is given with reference to FIG. 2 to FIG. 7. As shown in FIG. 2, the fixing device 1 includes the fixing belt 10, the pressure applying member 20, and the heater holding member 40.

The fixing belt 10 fixes the toner image T to the sheet S. That is, the fixing belt 10 is heated by the heater 30 described below and biased by the pressure applying member 20 such that the toner image T is fixed to the sheet S while the sheet S passes through the nip portion N between the fixing belt 10 and the pressure applying member 20.

The fixing belt 10 is endless. The fixing belt 10 is approximately cylindrical in shape. The fixing belt 10 is flexible. The fixing belt 10 is configured to peripherally rotate around a first rotation axis line L1. The fixing belt 10 extends along the first rotation axis line L1.

The fixing belt 10 includes an end portion 11, an end portion 12, the outer peripheral surface 13, and the inner peripheral surface 14. The end portions 11 and 12 are opposite ends of the fixing belt 10 in the direction along the first rotation axis line L1. In the following description, the direction along the first rotation axis line L1 may be denoted as “rotation axis direction”, “rotation axis direction of the fixing belt 10”, or “width direction of the fixing belt 10”.

In addition, a middle (center) 10c of the fixing belt 10 in the rotation axis direction may be denoted as “middle 10c of the belt”. In addition, the middle 10c may be denoted as “center 10c”. Furthermore, an imaginary line that passes through the middle 10c of the belt may be denoted as a middle line CL. The middle line CL may be denoted as “center line CL”.

The fixing belt 10 further includes a plurality of layers. The fixing belt 10 includes, for example, a polyimide layer and a release layer. The release layer is formed on the outer peripheral surface of the polyimide layer. The release layer is, for example, a heat-resistant film made of fluororesin.

FIG. 3 is a cross-section diagram taken along a line of FIG. 2. As shown in FIG. 3, the pressure applying member 20 forms the nip portion N that is in close contact with the outer peripheral surface 13 of the fixing belt 10. The pressure applying member 20 causes the fixing belt 10 to peripherally rotate in the peripheral rotation direction R1 while applying pressure to the fixing belt 10 at the nip portion N.

The pressure applying member 20 is approximately cylindrical and disposed to face the fixing belt 10. The pressure applying member 20 includes an outer peripheral surface 201. The pressure applying member 20 presses the fixing belt 10 in a direction indicated by the arrow B. This causes the outer peripheral surface 201 of the pressure applying member 20 to abut on the outer peripheral surface 13 of the fixing belt 10 to form the nip portion N.

The pressure applying member 20 is freely rotatable around a second rotation axis line L2 as its axial center. When the pressure applying member 20 rotates in a peripheral rotation direction R2, the fixing belt 10 rotates in the peripheral rotation direction R1 following the pressure applying member 20. With these configurations, when the sheet S passes through the nip portion N, the toner image T is fixed to the sheet S. It is noted that the sheet S is conveyed in a direction indicated by the arrow A (the positive side of the Z-axis). The pressure applying member 20 extends along the second rotation axis line L2. It is noted that the second rotation axis line L2 and the first rotation axis line L1 are approximately parallel to each other.

The pressure applying member 20 includes a columnar metal core 21, a cylindrical elastic layer 22, and a release layer 23. The elastic layer 22 is formed on the metal core 21. The release layer 23 is formed to cover the surface of the elastic layer 22. The metal core 21 is freely rotatable around the second rotation axis line L2 as its axial center. The metal core 21 is formed from, for example, stainless or aluminum. The elastic layer 22 is elastic, and is formed from, for example, silicone rubber. The release layer 23 is formed from, for example, fluororesin.

The heater holding member 40 holds the heater 30 that applies heat to the fixing belt 10. As shown in FIG. 2, the heater holding member 40 is configured such that a belt holding member 60 can be attached to an end portion of the heater holding member 40 in the direction along the first rotation axis line L1. The belt holding member 60 includes a first belt holding member 61 and a second belt holding member 62. The first belt holding member 61 holds the end portion 11 of the fixing belt 10. The second belt holding member 62 holds the end portion 12 of the fixing belt 10.

As shown in FIG. 3, the fixing belt 10 further includes an inner peripheral surface 14. In addition, the heater holding member 40 includes a heater holding portion 32.

The heater holding portion 32 includes a reinforcement member 33 and the heater 30. Specifically, the inner peripheral surface 14 of the fixing belt 10 faces the heater 30.

The reinforcement member 33 is configured to reinforce the heater holding member 40. The reinforcement member 33 is, for example, an elongated metal stay member. The reinforcement member 33 is, when viewed from the positive side of the Y-axis, approximately in the shape of inverted letter U. The reinforcement member 33 extends along the first rotation axis line L1.

The heater 30 applies heat to the fixing belt 10. The heater 30 extends along the first rotation axis line L1. The heater 30 is, for example, a surface heater or an elongated thin-plate heater. The heater 30 is, for example, a ceramic heater, and includes a ceramic substrate and a heating resistor. The heater 30 is, for example, 1 mm thick. The heater 30 receives a pressure from the pressure applying member 20 via the fixing belt 10.

The heater holding portion 32 of the heater holding member 40 holds the heater 30. The heater holding portion 32 faces the fixing belt 10 across the heater 30. The heater holding member 40 is disposed inside the tubular fixing belt 10 (on the opposite side from the outer peripheral surface 13 facing the pressure applying member 20). The heater holding member 40 is made from, for example, heat-resistant resin. The heater holding member 40 extends along the first rotation axis line L1. One of opposite ends of the heater holding member 40 in the direction along the first rotation axis line L1 is configured to fit to, for example, a connector provided in the main body of the image forming apparatus 100.

Next, the following describes the heater holding member 210 of the fixing device provided in a general image forming apparatus 200 with reference to FIG. 4 and FIG. 6, for comparison with the features of the present disclosure shown in FIG. 5 and FIG. 7.

FIG. 4 is an outline perspective diagram of the heater holding member 210 of the fixing device provided in the general image forming apparatus 200. FIG. 6 is a diagram of the area D shown in FIG. 4 viewed from a direction indicated by the arrow C. FIG. 5 is an outline perspective diagram of the heater holding member 40 of the fixing device 1 according to Embodiment 1 of the present disclosure. FIG. 7 is a diagram of the area F shown in FIG. 5 viewed from a direction indicated by the arrow E.

As shown in FIG. 4, the heater holding member 210 includes a side portion 220. A rib 230 is formed on the side portion 220. The heater holding member 210 is disposed inside a tubular fixing belt 240. A pressure applying belt 260 is disposed to face the fixing belt 240. The pressure applying belt 260 applies a pressure to the fixing belt 240.

In a fixing device provided in the general image forming apparatus 200, when the pressure applying belt 260 applies the pressure to the fixing belt 240, the pressure applying belt 260 and the fixing belt 240 come in contact with each other not only at a nip section 400, but also at a friction section 402. At the nip section 400, the pressure applying belt 260 and the fixing belt 240 form a nip, and the fixing belt 240 is heated by a heater (not shown).

The friction section 402 is a section where the pressure applying belt 260 and the fixing belt 240 come in close contact with each other on the downstream side in the peripheral rotation direction R1 of the fixing belt 240, after passing the nip section 400.

At the friction section 402, the fixing belt 240 slides with respect to the heater holding member 210.

The rib 230 is formed at a rib section 404 where the pressure applying belt 260 is separated from the fixing belt 240. The rib 230 guides the fixing belt 240 to peripherally rotate. At the rib section 404, the fixing belt 240 is in close contact with only the rib 230.

As shown in FIG. 4 and FIG. 6, the fixing belt 240 comes in close contact with the heater holding member 210 not only at the nip section 400 and the rib section 404, but also at the friction section 402. As a result, although the fixing belt 240 receives heat from the heater at the nip section 400, the heater holding member 210 removes heat from the fixing belt 240 at the friction section 402 and reduces the temperature of the fixing belt 240.

On the other hand, as shown in FIG. 5 and FIG. 7, the fixing device 1 provided in the image forming apparatus 100 according to Embodiment 1 of the present disclosure, includes the fixing belt 10, the pressure applying member 20, and the heater holding member 40.

The fixing belt 10 fixes the toner image T to the sheet S. The pressure applying member 20 forms a nip portion N together with an outer peripheral surface 13 of the fixing belt 10, and causes the fixing belt 10 to peripherally rotate in the peripheral rotation direction R2 by applying pressure to the fixing belt 10 at the nip portion N.

The heater holding member 40 holds the heater 30 (FIG. 3). The heater holding member 40 includes the side portion 44 and the plurality of ribs 52.

The side portion 44 extends from the fixing belt conveyance direction downstream end 416 of the nip portion N where the fixing belt 10 and the heater holding member 40 are in contact with each other, toward the downstream in the peripheral rotation direction R1 of the fixing belt 10.

The ribs 52 are formed on the side portion 44. The ribs 52 are formed to stand on the side portion 44 and extend from the fixing belt conveyance direction downstream end 416 of the nip portion N where the fixing belt 10 and the heater holding member 40 are in contact with each other, toward the downstream in the peripheral rotation direction R1 of the fixing belt 10, and the ribs 52 guide the fixing belt 10 to peripherally rotate.

The heater holding member 40 is disposed inside the tubular fixing belt 10. The pressure applying member 20 is disposed to face the fixing belt 10. The pressure applying member 20 applies a pressure to the fixing belt 10.

In the fixing device 1 according to Embodiment 1 of the present disclosure, a nip section 410 is formed where the pressure applying member 20 applies a pressure to the fixing belt 10. At the nip section 410, the pressure applying member 20 and the fixing belt 10 form the nip portion N, and the fixing belt 10 is heated by the heater 30.

The ribs 52 are formed at a rib section 412 where the pressure applying member 20 is separated from the fixing belt 10. The ribs 52 guide the fixing belt 10 to peripherally rotate. At the rib section 412, the fixing belt 10 is in close contact with only the ribs 52.

As shown in FIG. 5 and FIG. 7, the fixing belt 10 comes in close contact with the heater holding member 40 only at the nip section 410 and the rib section 412. As a result, after receiving heat from the heater 30 at the nip section 410, the fixing belt 10 is separated from the heater holding member 40 and the pressure applying member 20 and slides while in contact with only the ribs 52. This restricts reduction of the temperature.

As described above, according to the present embodiment, it is possible to restrict reduction of the temperature of the fixing belt 10.

Furthermore, as shown in FIG. 5, the heater holding member 40 may further include the upstream side portion 48 and the rib 54.

The upstream side portion 48 extends from the fixing belt conveyance direction upstream end 418 of the nip portion N where the fixing belt 10 and the heater holding member 40 are in contact with each other, toward the upstream in the peripheral rotation direction R1 of the fixing belt 10.

The rib 54 is formed to stand on the upstream side portion 48 and extend from the fixing belt conveyance direction upstream end 418 of the nip portion N where the fixing belt 10 and the heater holding member 40 are in contact with each other, toward the upstream in the peripheral rotation direction R1 of the fixing belt 10 along the upstream side portion 48, and the rib 54 guides the fixing belt 10 to peripherally rotate.

The rib 54 is formed at a rib section 414 where the pressure applying member 20 is separated from the fixing belt 10. The rib 54 guides the fixing belt 10 to peripherally rotate. At the rib section 414, the fixing belt 10 is in close contact with only the rib 54.

As shown in FIG. 5 and FIG. 7, the fixing belt 10 comes in close contact with the heater holding member 40 only at the rib section 414 and the nip section 410. As a result, after sliding while in contact with only the ribs 52 at the rib section 414, the fixing belt 10 enters the nip section 410. This restricts reduction of the temperature.

As described above, according to the present embodiment, it is possible to further restrict reduction of the temperature of the fixing belt 10.

### Embodiment 2

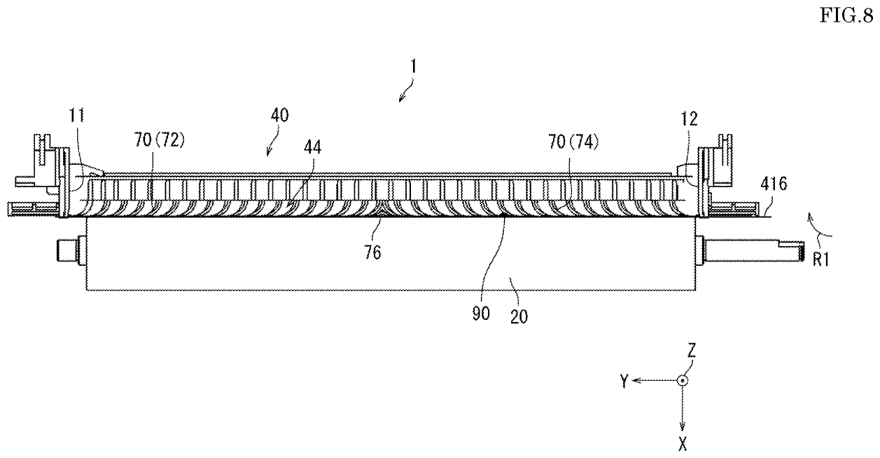

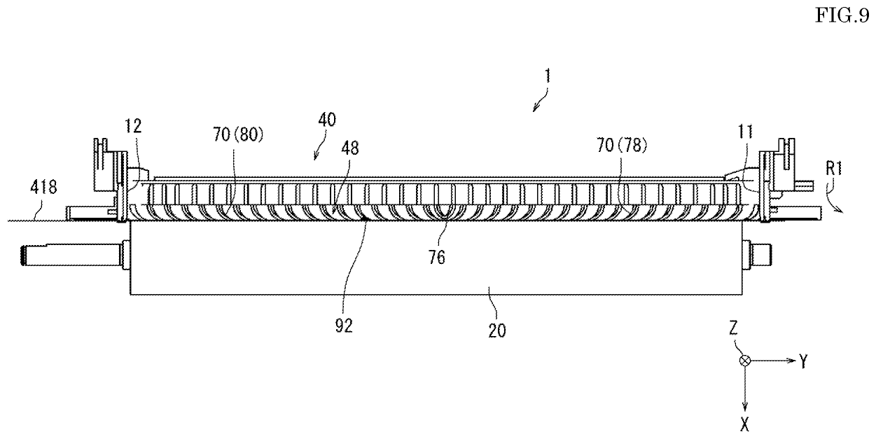

Next, the fixing device 1 according to Embodiment 2 is described with reference to FIG. 8 to FIG. 9, in addition to FIG. 1 to FIG. 7. FIG. 8 is a diagram of the heater holding member 40 of the fixing device 1 according to Embodiment 2 viewed from a positive side of Z-axis. FIG. 9 is a diagram of the heater holding member 40 of the fixing device 1 according to Embodiment 2 viewed from a negative side of Z-axis.

In Embodiment 2, a part or all of a plurality of ribs 70 (ribs 72, ribs 74, ribs 78, and ribs 80) are inclined toward a center portion 76 of the fixing belt 10 in the direction along the first rotation axis line L1 with respect to the peripheral rotation direction R1 of the fixing belt 10.

The configuration of Embodiment 2 is based on the configuration of Embodiment 1. As a result, description of components of Embodiment 2 overlapping with those of Embodiment 1 is omitted.

As shown in FIG. 8, the ribs 70 are formed to stand on the side portion 44 of the heater holding member 40. The side portion 44 extends toward the downstream in the peripheral rotation direction R1 of the fixing belt 10 with respect to the nip portion N where the fixing belt 10 and the heater holding member 40 are in contact with each other.

The ribs 70 are formed to stand on the side portion 44 and extend from the fixing belt conveyance direction downstream end 416 (FIG. 5 or FIG. 7) toward the downstream in the peripheral rotation direction R1 of the fixing belt 10.

The position on the heater holding member 40 at which the ribs 70 stand is the same as the position described in Embodiment 1 with reference to FIG. 5 and FIG. 7. That is, as shown in FIG. 8, a start point 90 of the ribs 70 on the upstream side in the peripheral rotation direction R1 of the fixing belt 10 is located at the fixing belt conveyance direction downstream end 416 of the nip section 410.

As shown in FIG. 8, the ribs 70 include the ribs 72 and the ribs 74. The ribs 72 and the ribs 74 are formed to stand on the side portion 44 of the heater holding member 40.

As described above with reference to FIG. 5, the side portion 44 extends from the fixing belt conveyance direction downstream end 416 of the nip section 410 of the nip portion N where the fixing belt 10 and the heater holding member 40 are in contact with each other, toward the downstream in the peripheral rotation direction R1 of the fixing belt 10.

A part or all of the ribs 70 are inclined toward the center portion 76 of the fixing belt 10 in the direction along the first rotation axis line L1 with respect to the peripheral rotation direction R1 of the fixing belt 10.

A lubricant is applied to an inner surface of the fixing belt 10 in order to reduce the friction between the fixing belt 10 and the heater holding member 40. However, as the fixing belt 10 peripherally rotates, the lubricant may be distributed in an unstable manner, and, for example, distributed in a biased state to the end portion 11 or the end portion 12 of the fixing belt 10.

With the configuration where the ribs 72 are inclined toward the center portion 76, it is possible to move the lubricant that has been distributed in a biased state to the end portion 11 of the fixing belt 10, toward the center portion 76 of the fixing belt 10.

Similarly, with the configuration where the ribs 74 are inclined toward the center portion 76, it is possible to move the lubricant that has been distributed in a biased state to the end portion 12 of the fixing belt 10, toward the center portion 76 of the fixing belt 10.

Next, as shown in FIG. 9, the ribs 70 include the ribs 78 and the ribs 80. The ribs 78 and the ribs 80 are formed to stand on the upstream side portion 48 of the heater holding member 40.

As described above with reference to FIG. 5, the upstream side portion 48 extends from the fixing belt conveyance direction upstream end 418 of the nip portion N where the fixing belt 10 and the heater holding member 40 are in contact with each other, toward the upstream in the peripheral rotation direction R1 of the fixing belt 10.

The position on the heater holding member 40 at which the ribs 78 and the ribs 80 stand is the same as the position described in Embodiment 1 with reference to FIG. 5 and FIG. 7. That is, an end point 92 of the ribs 70 on the upstream side in the peripheral rotation direction R1 of the fixing belt 10 is located at the fixing belt conveyance direction upstream end 418 of the nip section 410.

A part or all of the ribs 78 and the ribs 80 are inclined toward the center portion 76 of the fixing belt 10 in the direction along the first rotation axis line L1 with respect to the peripheral rotation direction R1 of the fixing belt 10.

With the configuration where the ribs 78 are inclined toward the center portion 76, it is possible to move the lubricant that has been distributed in a biased state to the end portion 11 of the fixing belt 10, toward the center portion 76 of the fixing belt 10.

Similarly, with the configuration where the ribs 80 are inclined toward the center portion 76, it is possible to move the lubricant that has been distributed in a biased state to the end portion 12 of the fixing belt 10, toward the center portion 76 of the fixing belt 10.

According to the present embodiment, with the configuration where the ribs 70 (the ribs 72, the ribs 74, the ribs 78, and the ribs 80) are inclined toward the center portion 76, it is possible to move the lubricant that has been distributed in a biased state to the end portion 11 or the end portion 12 of the fixing belt 10, toward the center portion 76 of the fixing belt 10, thereby causing the lubricant of the fixing belt 10 to circulate and be suitably distributed.

### Embodiment 3

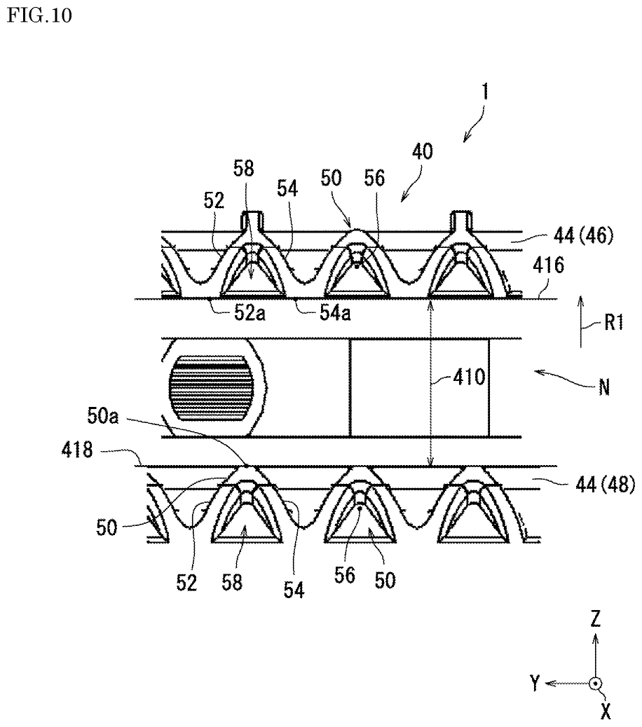

Next, the fixing device 1 according to Embodiment 3 is described with reference to FIG. 10, in addition to FIG. 1 to FIG. 9. FIG. 10 is a diagram of the heater holding member 40 of the fixing device 1 according to Embodiment 3 viewed from a positive side of X-axis.

In Embodiment 3, a plurality of ribs 52 and 54 adjacent to each other are formed such that the interval between them is gradually narrowed as they proceed toward the downstream in the peripheral rotation direction R1 of the fixing belt 10.

In addition, in Embodiment 3, the plurality of ribs 52 and 54 form a storage portion 58 to store the lubricant.

In addition, in Embodiment 3, the plurality of ribs 52 and 54 form a joint portion 56 at the downstream in the peripheral rotation direction R1 of the fixing belt 10 such that the lubricant accumulates in the joint portion 56, and the joint portion 56 supplies the lubricant to the fixing belt 10.

Hereinafter, in Embodiment 3, the rib 52 is referred to as an “inclined rib 52”. In addition, the rib 54 is referred to as an “inclined rib 54”.

As shown in FIG. 10, the heater holding member 40 includes the side portion 44, the inclined ribs 52, and the inclined ribs 54.

The side portion 44 guides the fixing belt 10 (FIG. 5) to peripherally rotate. The side portion 44 extends from opposite sides of the nip portion N of the heater holding member 40 in its short direction, along the inner peripheral surface 14 of the fixing belt 10.

As shown in FIG. 5, the side portion 44 includes a downstream side portion 46 and an upstream side portion 48.

The downstream side portion 46 extends from the nip portion N of the heater holding member 40 along the inner peripheral surface 14 of the fixing belt 10 toward the downstream in the peripheral rotation direction R1 in which the fixing belt 10 peripherally rotates.

The upstream side portion 48 extends from the nip portion N of the heater holding member 40 along the inner peripheral surface 14 of the fixing belt 10 toward the upstream in the peripheral rotation direction R1 in which the fixing belt 10 peripherally rotates.

The plurality of inclined ribs 52 and 54 are disposed on the side portion 44 to face the inner peripheral surface 14 of the fixing belt 10, and are formed such that the interval between them is gradually narrowed as they proceed in the peripheral rotation direction R1 in which the fixing belt 10 peripherally rotates.

The plurality of inclined ribs 52 and 54 of the heater holding member 40 are disposed on the downstream side portion 46.

A start point 52a of the inclined rib 52 is located at the fixing belt conveyance direction downstream end 416 of the nip section 410.

The heater holding member 40 includes the storage portion 58 formed between the inclined rib 52 and the inclined rib 54 to store the lubricant.

Specifically, the inclined rib 52 and the inclined rib 54 are disposed at least on the downstream side portion 46 of the heater holding member 40 to face the inner peripheral surface 14 of the fixing belt 10. The inclined rib 52 and the inclined rib 54 adjacent to each other are formed such that the interval between them is gradually narrowed as they proceed in the peripheral rotation direction R1 in which the fixing belt 10 peripherally rotates.

It is preferable that a plurality of inclined ribs 52 and a plurality of inclined ribs 54 are provided. However, the present disclosure is not limited to the configuration where the plurality of inclined ribs 52 and the plurality of inclined ribs 54 are provided. In addition, the inclined rib 52 and the inclined rib 54 adjacent to each other may not join.

The plurality of inclined ribs 52 and 54 of the heater holding member 40 may be disposed on the upstream side portion 48.

An end point 50a of the inclined rib 52 is located at the fixing belt conveyance direction upstream end 418 of the nip section 410.

The heater holding member 40 includes the storage portion 58 formed between the inclined rib 52 and the inclined rib 54 to store the lubricant.

Specifically, the inclined rib 52 and the inclined rib 54 are disposed at least on the upstream side portion 48 of the heater holding member 40 to face the inner peripheral surface 14 of the fixing belt 10. The inclined rib 52 and the inclined rib 54 adjacent to each other are formed such that the interval between them is gradually narrowed as they proceed in the peripheral rotation direction R1 in which the fixing belt 10 peripherally rotates.

It is preferable that a plurality of inclined ribs 52 and a plurality of inclined ribs 54 are provided. However, the present disclosure is not limited to the configuration where the plurality of inclined ribs 52 and the plurality of inclined ribs 54 are provided. In addition, the inclined rib 52 and the inclined rib 54 adjacent to each other may not join.

Next, the behavior of lubricant in the heater holding member 40 is described with reference to FIG. 10. In a case where the inclined rib 52 and the inclined rib 54 adjacent to each other are formed not to join, when the fixing belt 10 peripherally rotates in the peripheral rotation direction R1, the lubricant applied to the inner peripheral surface 14 of the fixing belt 10 comes in contact with, and is collected by, the inclined rib 52 or the inclined rib 54.

As the fixing belt 10 further peripherally rotates, the lubricant is stored and accumulated in the storage portion 58 between the inclined rib 52 and the inclined rib 54. Furthermore, due to the configuration where the interval between the inclined rib 52 and the inclined rib 54 adjacent to each other is gradually narrowed, the lubricant is pushed out to the peripheral rotation direction R1 side of the inclined rib 52 and the inclined rib 54, and accumulates in the joint portion 56 while being circulated.

Even in a case where the inclined rib 52 and the inclined rib 54 adjacent to each other are formed not to join, the joint portion 56 may be a region where the inclined rib 52 and the inclined rib 54 adjacent to each other are most close to each other.

The lubricant that has accumulated in the joint portion 56 is pushed out by the lubricant supplied later, overflows from the joint portion 56, and is re-supplied to the inner peripheral surface 14 of the fixing belt 10.

According to the present embodiment, it is possible to restrict the lubricant stored in the joint portion 56 from being deposited between the inclined rib 52 and the inclined rib 54, and the lubricant is re-supplied to the inner peripheral surface 14 of the fixing belt 10. As a result, it is possible to suitably circulate the lubricant between the fixing belt 10 and the heater holding member 40 and prevent coagulation of the lubricant.

According to the present embodiment, the storage portion 58 formed between the inclined rib 52 and the inclined rib 54 is configured to store the lubricant applied to the inner peripheral surface 14 of the fixing belt 10.

According to the present embodiment, it is possible to re-supply the lubricant from the joint portion 56 where the inclined rib 52 and the inclined rib 54 adjacent to each other come closest to each other, to the inner peripheral surface 14 of the fixing belt 10. As a result, it is possible to suitably circulate the lubricant between the fixing belt 10 and the heater holding member 40 and prevent coagulation of the lubricant.

Next, with reference to FIG. 10, a joint rib 50 where the inclined rib 52 and the inclined rib 54 join is described.

The joint rib 50 is formed such that the inclined rib 52 and the inclined rib 54 approach each other as they proceed in the peripheral rotation direction R1 in which the fixing belt 10 peripherally rotates, and join at the joint portion 56.

The joint rib 50 includes the storage portion 58 to store the lubricant in a space between the inclined rib 52 and the inclined rib 54.

The joint rib 50 includes the joint portion 56 at which the inclined rib 52 and the inclined rib 54 join. At the joint portion 56, the lubricant stored in the storage portion 58 accumulates. The joint portion 56 supplies the lubricant to the fixing belt 10.

The start points 52a and 54a of the joint rib 50 are located at the fixing belt conveyance direction downstream end 416 of the nip section 410.

Next, the behavior of lubricant in the heater holding member 40 is described. When the fixing belt 10 peripherally rotates in the peripheral rotation direction R1, the lubricant applied to the inner peripheral surface 14 of the fixing belt 10 comes in contact with the joint rib 50, and is collected by the inclined rib 52 or the inclined rib 54 of the joint rib 50.

As the fixing belt 10 further peripherally rotates, the lubricant is stored and accumulates in the storage portion 58 between the inclined rib 52 and the inclined rib 54. Due to the configuration where the interval between the inclined rib 52 and the inclined rib 54 adjacent to each other is gradually narrowed, the lubricant is pushed out to the peripheral rotation direction R1 side of the inclined rib 52 and the inclined rib 54, and accumulates in the joint portion 56 while being circulated.

The lubricant that has accumulated in the joint portion 56 is pushed out by the lubricant supplied later, overflows from the joint portion 56, and is re-supplied to the inner peripheral surface 14 of the fixing belt 10.

Furthermore, the joint portion 56 may be inclined toward the downstream in the peripheral rotation direction R1 in which the fixing belt 10 peripherally rotates.

According to the present embodiment, the lubricant stored in the storage portion 58 of the joint rib 50 is not deposited between the inclined rib 52 and the inclined rib 54, but is re-supplied from the joint portion 56 to the inner peripheral surface 14 of the fixing belt 10. As a result, it is possible to suitably circulate the lubricant between the fixing belt 10 and the heater holding member 40 and prevent coagulation of the lubricant.

According to the present embodiment, with the configuration where the joint portion 56 is inclined toward the downstream in the peripheral rotation direction R1 in which the fixing belt 10 peripherally rotates, the lubricant is further suitably re-supplied from the joint portion 56 to the inner peripheral surface 14 of the fixing belt 10. As a result, it is possible to prevent coagulation of the lubricant.

Furthermore, according to the present embodiment, the plurality of inclined ribs 52 and 54 are disposed on the downstream side portion 46. With this configuration, it is possible to suitably reduce the friction between the fixing belt 10 that passes through the nip portion N and the heater holding member 40, and suitably circulate the lubricant between the fixing belt 10 and the heater holding member 40.

Next, the side portion 44 may include the upstream side portion 48 that extends from the nip portion N to the upstream in the peripheral rotation direction R1 in which the fixing belt 10 peripherally rotates, and the joint rib 50 and the inclined rib 52 and the inclined rib 54 constituting the joint rib 50 may be disposed on the upstream side portion 48.

As shown in FIG. 10, the heater holding member 40 includes the upstream side portion 48 that extends from the nip portion N of the heater holding member 40 along the inner peripheral surface 14 of the fixing belt 10 toward the upstream in the peripheral rotation direction R1 in which the fixing belt 10 peripherally rotates.

The joint rib 50 may be disposed on the upstream side portion 48. The joint rib 50 may be disposed only on the upstream side portion 48, not disposed on the downstream side portion 46. The joint rib 50 may be disposed on both the downstream side portion 46 and the upstream side portion 48.

The end point 50a of the joint rib 50 is located at the fixing belt conveyance direction upstream end 418 of the nip section 410.

After passing through the downstream side portion 46, the fixing belt 10 peripherally rotates without restraint relatively for a long time. As a result, the lubricant applied to the inner peripheral surface 14 of the fixing belt 10 may flow to the end portion 11 or the end portion 12 shown in FIG. 2, and may flow out from the end portion 11 or the end portion 12. In addition, the lubricant may be applied in an unstable manner to the inner peripheral surface 14 of the fixing belt 10. Furthermore, the lubricant may oxidize when it is exposed to a space.

The joint rib 50 disposed on the upstream side portion 48 collects the lubricant applied to the inner peripheral surface 14 of the fixing belt 10, and re-supplies the lubricant to the inner peripheral surface 14 of the fixing belt 10.

According to the present embodiment, with the configuration where the joint rib 50 is disposed on the upstream side portion 48, it is possible to restrict the oxidation of the lubricant, and restrict the lubricant from flowing out from the end portion 11 or the end portion 12. Furthermore, with the configuration where the joint rib 50 is disposed on the upstream side portion 48, it is possible to apply the lubricant to the inner peripheral surface 14 of the fixing belt 10 in a stable manner.

Furthermore, according to the present embodiment, with the configuration where the joint rib 50 is disposed on both the downstream side portion 46 and the upstream side portion 48, it is possible to further suitably circulate the lubricant between the fixing belt 10 and the heater holding member 40.

Embodiments of the present disclosure have been described above with reference to the accompanying drawings. However, the present disclosure is not limited to the above-described embodiments, but may be implemented in various manners without departing from the scope of the present disclosure. In the drawings, the components are shown schematically for easy understanding, and the components are drawn as different from the actual ones in thickness, length, number, and so on for the sake of drawing. In addition, the material, shape, measurement and the like of each component are not limited to those described in the embodiments, but may be varied without departing from the effect of the present disclosure.

The present disclosure is applicable to the fields of the fixing device and the image forming apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device comprising:
a fixing belt configured to fix a toner image to a sheet;
a pressure applying member forming a nip portion together with an outer peripheral surface of the fixing belt and configured to cause the fixing belt to peripherally rotate while applying pressure to the fixing belt at the nip portion; and
a heater holding member holding a heater that applies heat to the fixing belt, wherein
the heater holding member includes:
a side portion extending from the nip portion along an inner peripheral surface of the fixing belt and configured to guide the fixing belt; and
a rib formed to stand on the side portion and extend from a fixing belt conveyance direction downstream end of the nip portion where the fixing belt and the heater holding member are in contact with each other, toward a downstream in a peripheral rotation direction of the fixing belt, and guide the fixing belt to peripherally rotate.

2. The fixing device according to claim 1, wherein
the heater holding member further includes:
another rib formed to stand on the side portion and extend from a fixing belt conveyance direction upstream end of the nip portion where the fixing belt and the heater holding member are in contact with each other, toward an upstream in the peripheral rotation direction of the fixing belt, and guide the fixing belt to peripherally rotate.

3. The fixing device according to claim 1, wherein
a part or all of a plurality of ribs are inclined toward a center portion of the fixing belt in a direction along a rotation axis of the fixing belt with respect to the peripheral rotation direction of the fixing belt.

4. The fixing device according to claim 1, wherein
a plurality of ribs adjacent to each other are formed such that an interval between the ribs is gradually narrowed as the ribs proceed toward the downstream in the peripheral rotation direction of the fixing belt.

5. The fixing device according to claim 4, wherein
the plurality of ribs form a storage portion to store lubricant.

6. The fixing device according to claim 5, wherein
the plurality of ribs form a joint portion at the downstream in the peripheral rotation direction of the fixing belt such that the lubricant accumulates in the joint portion, and the joint portion supplies the lubricant to the fixing belt.

7. An image forming apparatus comprising:
the fixing device according to claim 1; and
an image forming portion configured to form an image on the sheet.
